(19) United States
(12) Patent Application Publication
(10) Pub. No.: US 2009/0184900 A1
(43) Pub. Date: Jul. 23, 2009

(54) Image display device and display device control method

(76) Inventors: Philippe Le Roy, Betton (FR); Dominique Gagnot, Charavines (FR); Hassane Guermoud, Rennes (FR)

Correspondence Address: Thomson Licensing LLC, P.O. Box 5312, Two Independence Way, PRINCETON, NJ, 08543-5312, US

(21) Appl. No.: 11/658,944

(22) PCT Filed: Jul. 29, 2005
(86) PCT No.: PCT/FR2005/051005

§ 371 Date: Nov. 20, 2008

(30) Foreign Application Priority Data
Dec. 1, 2004 (FR) 0452832

(51) Int. Cl. G09G 3/30

(52) U.S. Cl. 345/77

(57) ABSTRACT

The invention relates to an active matrix image display device consisting of: several light emitters; a current modulator which is connected to each emitter; means for selecting emitters; means for powering the emitters; and an operational amplifier comprising an inverting input a noninverting input and an output. According to the invention, either the noninverting input or the inverting input of the operational amplifier is connected to the output of the power supply means such as to form, together with the modulator gate which is connected to the output of the operational amplifier, a feedback loop for the operational amplifier, when one of the emitters is selected. The invention also relates to a method of controlling one such display device.

The present invention relates to a display device, a display control circuit and a method for displaying images.

In particular, the present invention relates to an active-matrix image display device, comprising:
several light emitters forming an array of emitters distributed in rows and columns, each emitter being able to be addressed periodically by a value of a display signal, which value is representative of a datum of display of an image duration;
a current modulator linked in series to each light emitter of the array so as to form emitter-modulator series, the said modulator comprising a source, a drain, a gate, the said modulator being able to be traversed by a drain current so as to power the said emitter, for a voltage between one out of the drain and source, and the gate greater than or equal to a trip threshold voltage of this modulator;
a storage capacitor for electric charge, able to maintain a control voltage at the gate of each modulator for the said image duration;
selection means able to select the emitters of one and the same row; and
means of driving the illumination of the emitters comprising, for each column, means for powering these emitters comprising an output connected to one of the ends of each emitter-modulator series of the said column and at least one operational amplifier for controlling the corresponding modulators having an inverting input (−), a non-inverting input (+), and an output, the said output of the amplifier being able to be connected to the gate of each modulator of this column when an emitter linked to this modulator is selected, so as to apply to the said gate, the said control voltage.

Image display devices are increasingly being used in all sorts of applications such as in motor vehicles, digital cameras or portable telephones.

Display devices are known in which the light emitters are formed on the basis of organic light-emitting cells such as display devices of OLED (Organic Light Emitting Diode) type.

In particular, passive-matrix OLED display devices are already widely available on the market. However, they consume a great deal of electrical energy and have a shortish lifetime.

Active-matrix OLED display devices comprise integrated electronics, and exhibit numerous advantageous such as lowish consumption, high resolution, compatibility with video rates and a longer lifetime than passive-matrix OLED display devices.

Conventionally, these display device comprise an active matrix formed in particular by an array of light emitters. Each light emitter is tied to a pixel or to a subpixel of an image to be displayed and is addressed by an array of column electrodes and of row electrodes, via an addressing circuit.

The addressing circuits comprise in particular current modulators able to drive the current passing through the emitters and hence the luminance of each pixel or subpixel of the display device.

In an active matrix, these modulators are thin film transistors TFTs, fabricated from polycrystalline silicon according to the low temperature polycrystalline silicon (LTPS) technology on the basis of an amorphous silicon layer. However, this technology introduces local spatial variations of the trip threshold voltage between these transistors. These variations are due to the fact that the bonds and the dimensions of the grains of silicon are not sufficiently controllable during the step of crystallization of the amorphous silicon (Si-a) into polycrystalline silicon (Poly-Si).

Consequently, TFT transistors powered by the same supply voltage and controlled by identical display currents or voltages generate currents of different intensities. Moreover, the trip threshold voltages of thin film transistors are liable to vary in an inhomogeneous manner over time.

Now, as an emitter emits a luminous intensity directly proportional to the current which passes through it, the heterogeneity of the trip thresholds of these transistors leads to a nonuniformity of the brightness of the display device comprising such transistors. This results in differences between the luminance levels and manifest visual discomfort for the user.

In order to limit this discomfort, diverse circuits for compensating for the trip threshold voltage have been proposed.

For example, document EP-1 340 019 describes a display device comprising a compensation circuit comprising an operational amplifier whose output is linked to the gate of a modulator and whose non-inverting input is linked in succession to the anode of each emitter of one and the same column, without involving the modulator associated with the said emitter.

Nevertheless, this device is extremely complicated. It requires in particular the control of a large number of switches.

The aim of the present invention is the implementation of a simpler display device.

For this purpose, the subject of the present invention is an active-matrix image display device characterized in that one out of the non-inverting input and the inverting input of the operational amplifier is connected to the said output of the powering means so as to form, with the gate of the modulator, linked to the output of the operational amplifier, a loop for feedback of the operational amplifier, when one of the said emitters is selected.

Thus, in contradistinction to the pixel circuits described in document EP-1340019 already cited, the input of the operational amplifier is not connected to the common terminal of the emitter-modulator series of each pixel, but to one of the ends of this series.

The invention therefore makes it possible to directly command the current for powering the emitters in each column for powering the emitters, at least during the addressing period of these emitters. An advantage of the invention is that this command is performed without measurement of this current.

Each emitter is addressed periodically, at each image to be displayed, or several times for each image, depending on the method of display used.

According to particular embodiments, the device comprises one or more of the following characteristics.

One of the said ends of each emitter-modulator series of the said column, which is connected to the output of the said powering means, corresponds to the drain or to the source of the said modulators.

The output of the operational amplifier 35 then delivers a control signal V_{c} dependent on the display signal V_{data 22}, V_{data 23} and on the trip threshold voltage Vₜₕ of the modulator 26, linked to the selected emitter 22, 23, 24. The control signal V_{c} is able to charge the capacitor 30.

One out of the non-inverting input (+) and the inverting input (−) of the operational amplifier, connected to the output is able to receive a signal dependent on the value of the display signal, which value is intended to be addressed to a selected emitter from the said column.

According to a first main variant, the said powering means furthermore comprise a drive generator which is suitable for feeding power discontinuously in succession to each of the emitters of a column by provision of a drive signal to one of the said ends of the emitter-modulator series corresponding to the said emitter, the said drive signal depending on the value of the display signal, which value is intended to be addressed to a selected emitter from the said column. So, the drive generator powers one emitter after another, only during its addressing period.

The powering means then generally furthermore comprise a sustain generator the function of which is to power the emitters of the column outside of their addressing phases. Such a device requires switching means suitable for toggling the powering of the emitters between the drive generator and the sustain generator. In practise, there are therefore generally two additional switches in each addressing circuit, one for connecting the emitter-modulator series of this circuit to the addressing generator during the addressing phases, the other for connecting this emitter-modulator series to the sustain generator outside of the addressing phases.

As mentioned previously, the output of the drive generator is connected to one out of the non-inverting input (+) and the inverting input (−) of the operational amplifier. Only during the addressing of an emitter of this column, this same output is also connected, via a switch closed for addressing, to the said end of the corresponding emitter-modulator series.

The said drive generator comprises a display voltage generator and a resistive element linked in series, and the voltage generator is suitable for generating a voltage dependent on the value of the display signal, which value is intended to be addressed to a selected emitter from the said column.

This resistor may be a resistor internal to the voltage generator.

By virtue of this series resistor, the value of the current which flows in this resistor and therefore in this emitter during its addressing period is independent of the trip threshold voltage of the modulator associated with this emitter. The value of the current is then on the one hand proportional to the difference between the said value of the display signal and the value of the voltage applied to the other out of the non-inverting input and the inverting input of the operational amplifier, on the other hand inversely proportional to the value of the resistance of the resistive element.

According to a second preferred main variant, said powering means comprise a drive generator able to supply power continuously to the whole set of emitters of a column by providing one and the same drive signal to one of the ends of each emitter-modulator series of a column, the said drive signal being dependent on the sum of the values of the display signal that were previously addressed and are currently being addressed to the whole set of emitters of the column for an image duration. Advantageously, a additional sustain generator is not needed, as its was needed in the previous first main variant.

The said drive generator comprises a display voltage generator and a resistive element linked in series, and the voltage generator is suitable for generating a voltage dependent on the sum of the values of the display signal that were previously addressed and are currently being addressed to the whole set of emitters of the column for an image duration.

This resistor may be a resistor internal to the voltage generator. By virtue of this series resistor, the value of the current which flows in this resistor and therefore in this emitter is independent of the trip threshold voltage of the modulator associated with this emitter. The value of the current is then on the one hand proportional to the difference between the said sum of the values of the display signal and the value of the voltage applied to the other out of the non-inverting and the inverting input of the operational amplifier, on the other hand inversely proportional to the value of the resistance of the resistive element.

It comprises no means of switching between the said output of the powering means and each of the ends of the emitter-modulator series of the column. Advantageously, the addressing circuits of emitters are simplified in comparison with the first main variant, because it is not needed any more to switch one of the ends of the emitter-modulator series alternatively between the different drive generators, as it was needed in the first main variant.

The output of the drive generator is connected on the one hand to one out of the non-inverting input (+) and the inverting input (−) of the operational amplifier, on the other hand, without intermediate switch, to the said end of the corresponding emitter-modulator series.

The voltage generator is linked to the resistive element so as to deliver a drive current obtained on the basis of the following relation:

$$I = \frac{( {\sum }_{n = l}^{p} {V}_{data n} ) - {V}_{ref n}}{R}$$

in which R is the resistive element,

V_{ref n} is a reference voltage associated with emitter n, and

V_{data n} is the value of the display voltage addressed to emitter n, and

P is the total number of emitters in a column.

The said drive means furthermore comprise a reference generator able to deliver a reference signal to the other out of the inverting input (−) and the non-inverting input (+) of the operational amplifier.

Each emitter exhibits particular electrical and/or optical properties and the value of each reference signal is dependent on the said electrical and/or optical properties.

Each emitter is associated with the illumination of a colour, and the reference signal is able to be modulated as a function of the colour assigned to the said selected emitter.

A given white hue is conventionally labelled by its trichromatic coordinates. By virtue of the invention, the chromatic performance of the device can easily be optimized and the differences in ageing between the emitters can be compensated for.

The emitters are grouped into pluralities of adjacent emitters suitable for each emitting a different colour, and, for each plurality, the said reference signals are allocated to the various emitters of this plurality in such a way that the addressing of these emitters by one and the same display signal value brings about the emission of the said white hue by this plurality.

The said drive means furthermore comprise data storage means able to store the value of the display signal which is addressed to each emitter for an image duration.

The subject of the invention is also a method for active-matrix image display device comprising several light emitters forming an array of emitters distributed in rows and columns, each emitter being able to be addressed periodically by a value of a display signal, which value is representative of a datum of display for an image duration; a current modulator comprising a source, a drain, a gate, one of the drain or the source of each modulator being linked in series to an emitter of the array so as to form an emitter-modulator series comprising two ends; selection means able to select the emitters of a row; a storage capacitor for electric charge, able to maintain a control voltage at the gate of the or each modulator for the said image duration; means of driving the illumination of the emitters of a column comprising at least one operational amplifier having an inverting input, a non-inverting input and an output, the method comprising the following steps
transmission by the means of selection, of a selection signal (V_{select}) to a row of emitters;
application by the drive means of a drive signal (I) to one of the ends of each emitter-modulator series of a column; and
application by the drive means of a control signal (V_{c}) to the gate of each modulator, linked to the selected emitter;

characterized in that it furthermore comprises the following step:
selection of a row of emitters so as to form a loop for feedback of the operational amplifier with the gate of the modulator, linked to the output of the operational amplifier, and with one out of the non-inverting input and the inverting input of the operational amplifier, linked to the said output of the means of powering of these emitters.

According to a particular embodiment, the method comprises the characteristic according to which the drive signal is dependent on the sum of the values of the display signals addressed to the whole set of emitters of the column for an image duration.

The invention will be better understood on reading the description which follows, given merely by way of example and offered while referring to the appended drawings, in which:

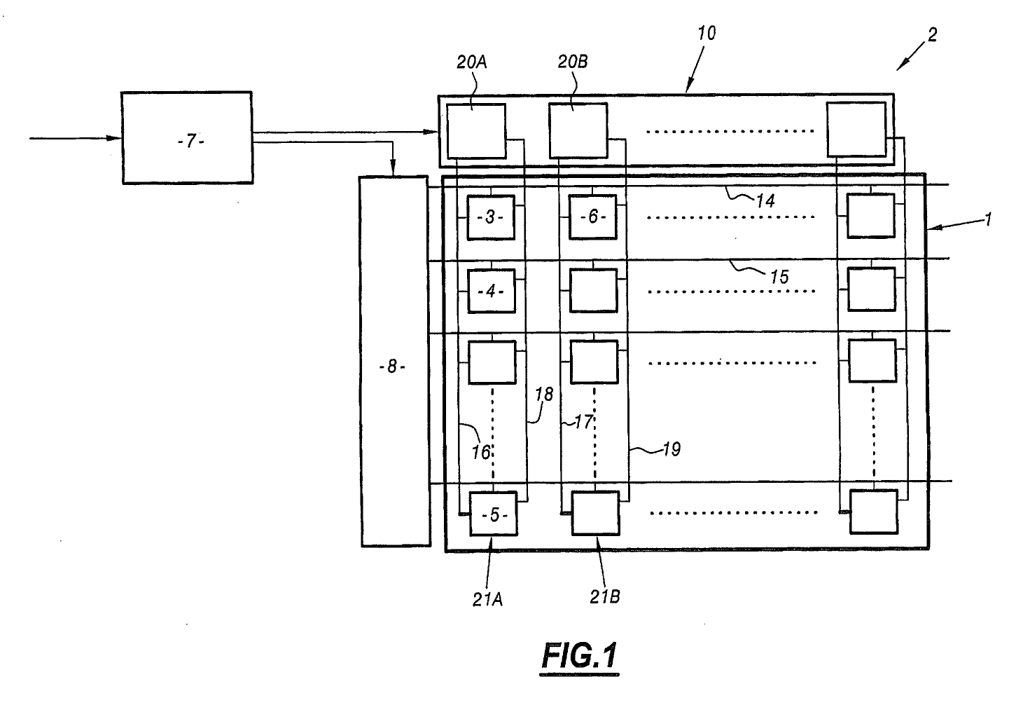

FIG. 1 is a schematic diagram of a display device according to the invention;

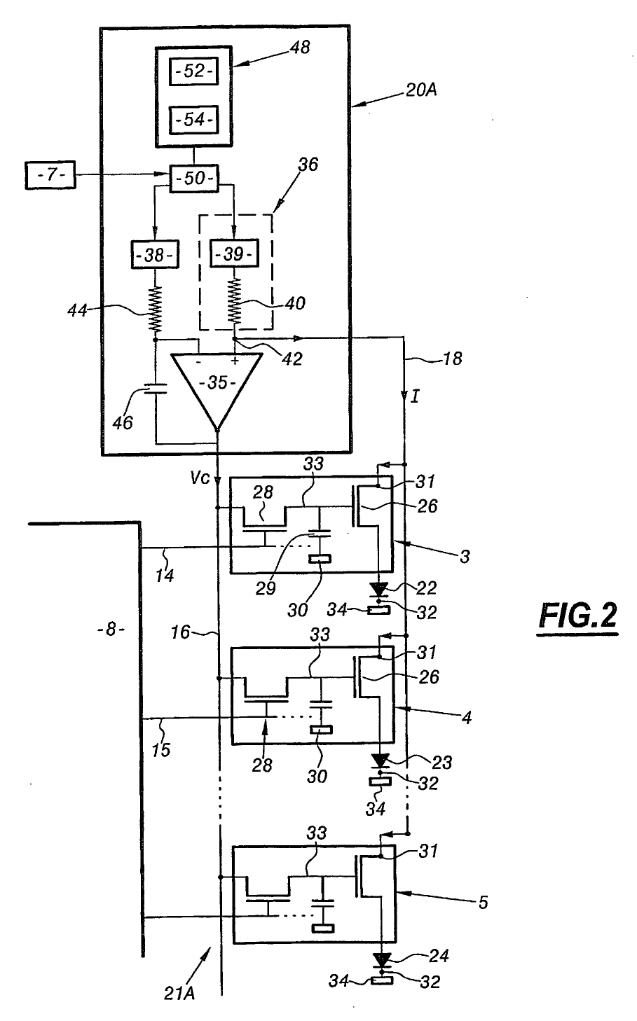

FIG. 2 is a schematic diagram of a part of the display device represented in FIG. 1;

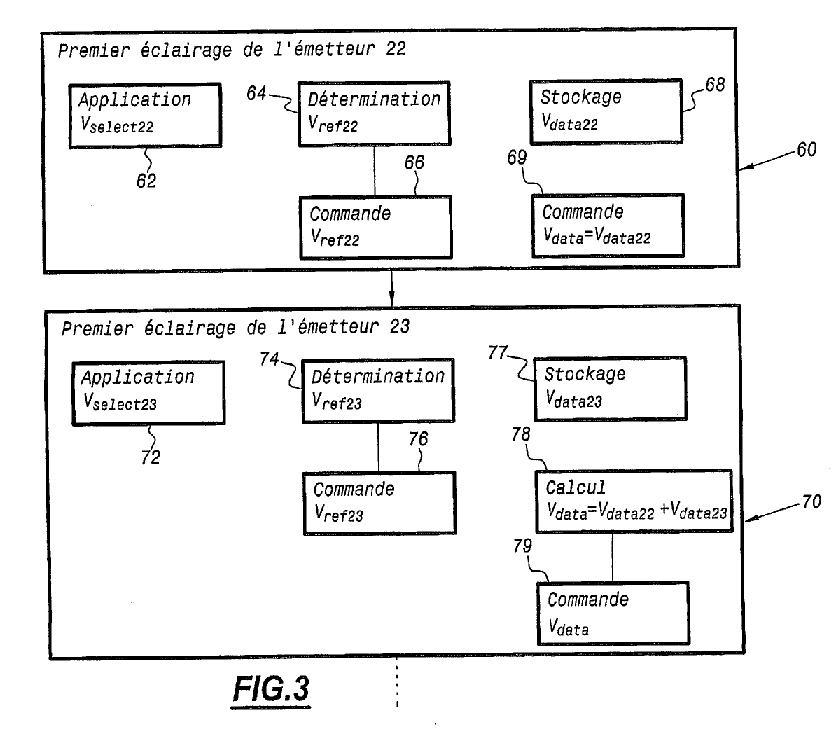

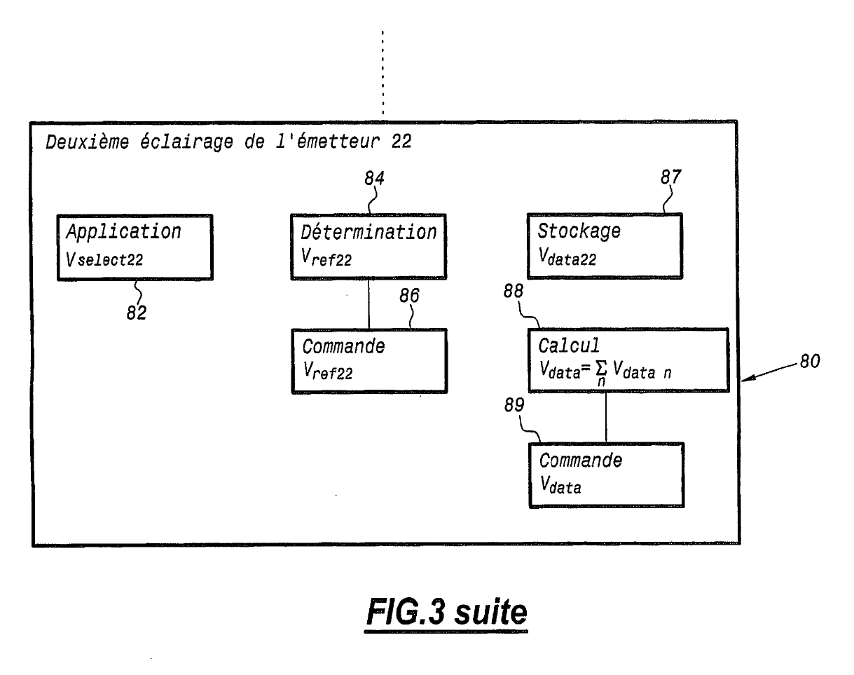

FIG. 3 is a chart diagrammatically representing a few steps of the control method according to the invention;

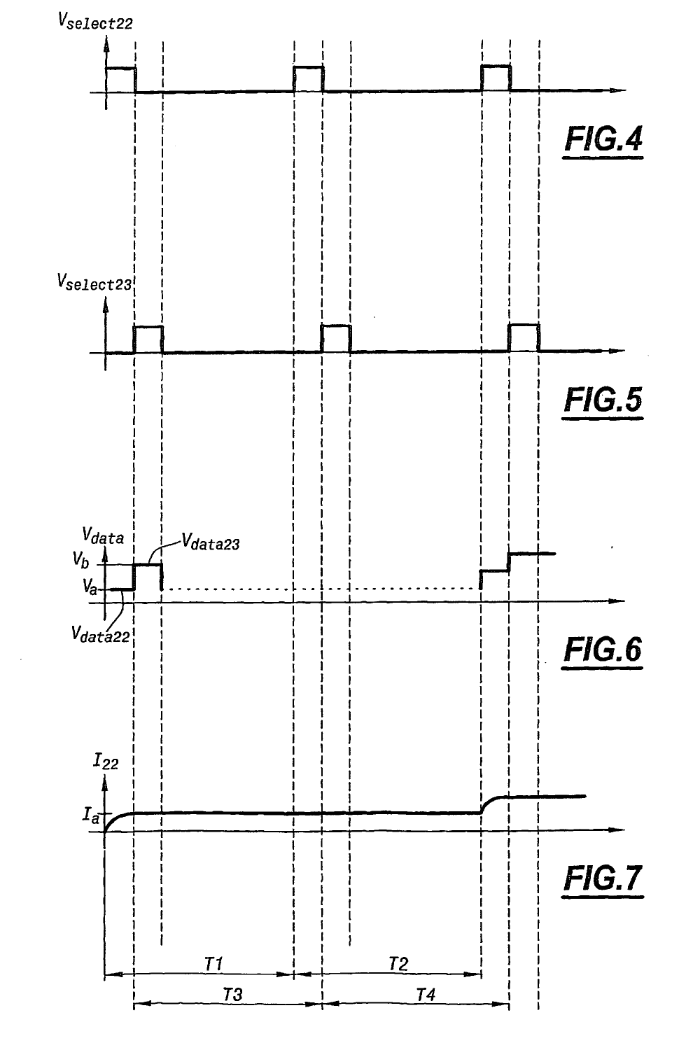

FIG. 4 is a graph representing the time profile of a selection voltage applied to a selection electrode of a first addressing circuit of the display device according to the invention;

FIG. 5 is a graph representing the time profile of a selection voltage applied to a selection electrode of a second addressing circuit of the display device according to the invention;

FIG. 6 is a graph representing the time profile of a display voltage generated by a drive generator for addressing in succession various addressing circuits of one and the same column of the display device according to the invention, in particular the first and the second circuits;

FIG. 7 is a graph representing the time profile of a drain current flowing through a modulator of the first addressing circuit;

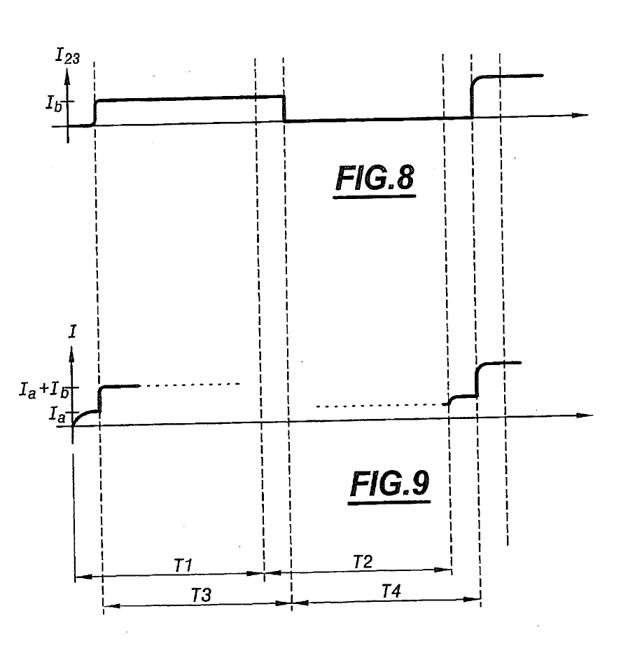

FIG. 8 is a graph representing the time profile of a drain current flowing through a modulator of the second addressing circuit of the display device according to the invention;

FIG. 9 is a graph representing the time profile of a drive current generated by a drive unit of the display device according to the invention;

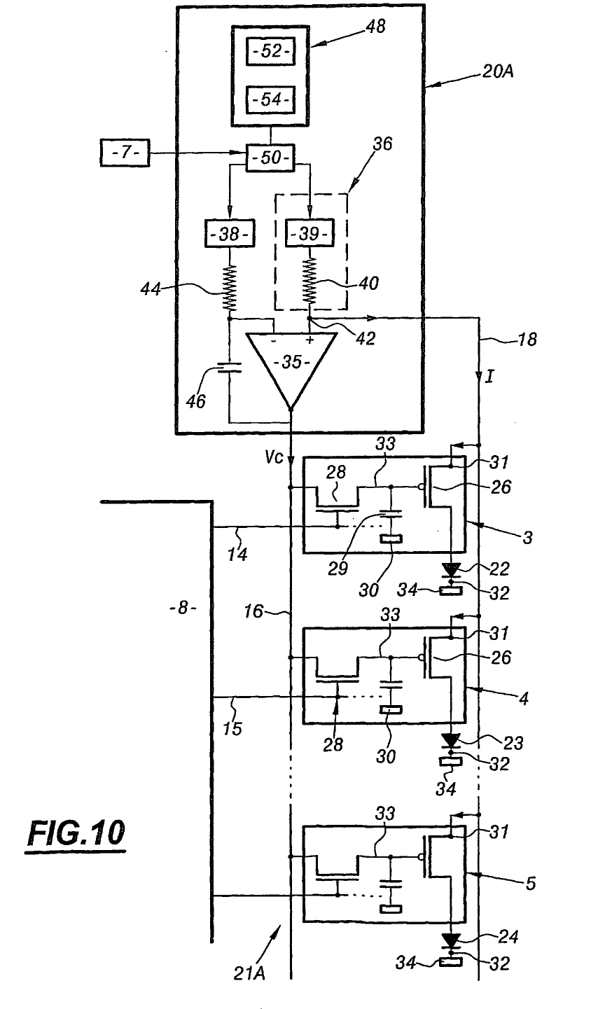

FIG. 10 is a schematic diagram of a first variant embodiment of the part represented in FIG. 2 of the display device;

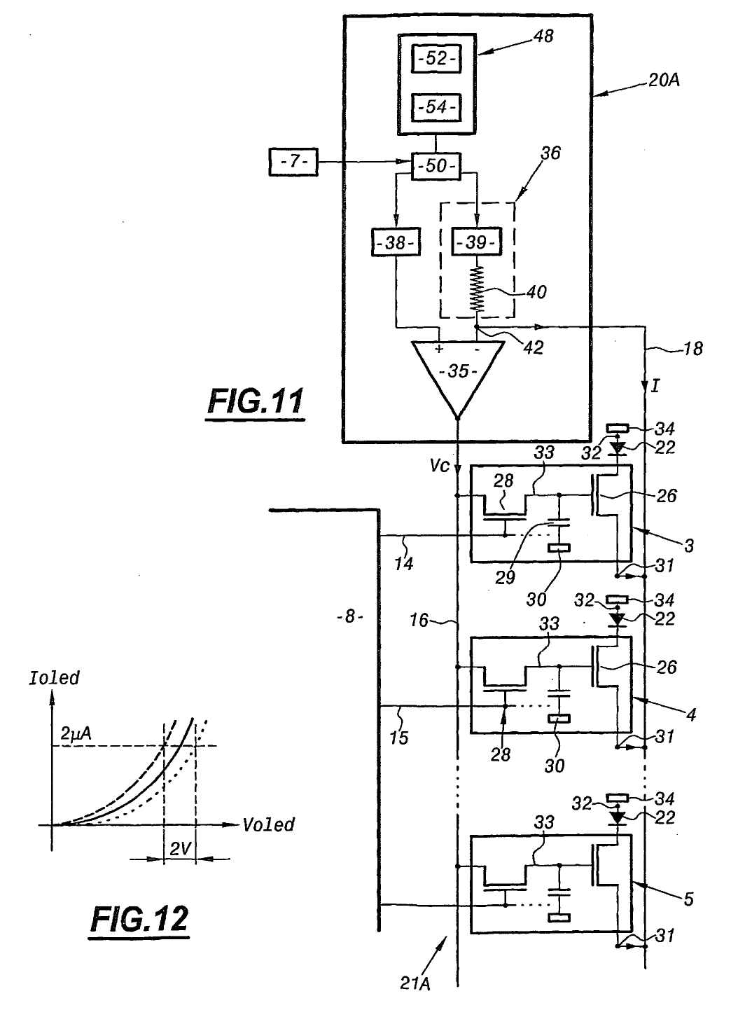

FIG. 11 is a schematic diagram of a second variant embodiment of the part represented in FIG. 2 of the display device; and

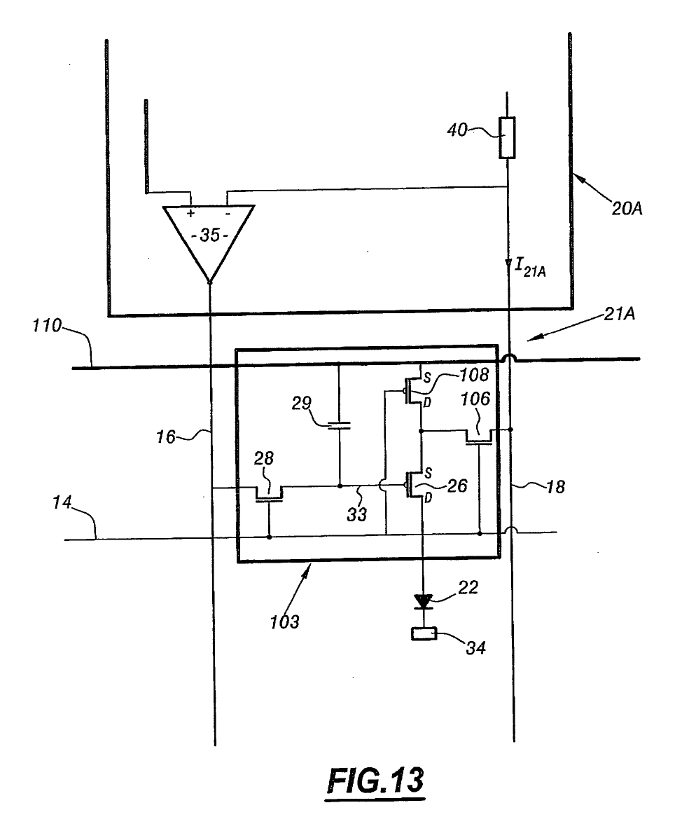

FIG. 12 is a graph comprising curves representing the current passing through various emitters of the display device according to the invention, as a function of the voltage applied to their terminals.

FIG. 1 represents an image display device according to the invention. The latter consists of an active matrix 1 driven by control means 2.

In a manner known per se, the active matrix 1 comprises a plurality of addressing circuits 3, 4, 5, 6, each associated with an emitter (not represented) and distributed according to rows and columns.

The means 2 of control of the active matrix comprise a control system 7, a selection control circuit 8 and an addressing control circuit 10.

The control system 7 is able to receive an image display signal, to process it (for example, decode it and decompress it) and to deliver a synchronization signal to the selection control circuit 8 and display signals to the addressing control circuit 10.

The selection control circuit 8 is linked to a plurality of row electrodes 14, 15 each associated with a row of emitters. On receipt of the synchronization signal, the circuit 8 is suitable for generating a selection pulse V_{select} in succession at each row electrode 14, first to select in turn the whole set of addressing circuits 3, 6 of this row, at a scanning frequency corresponding to an image duration. The selection pulse V_{select} is a logic datum for selecting the emitters.

The addressing control circuit 10 is linked to a plurality of column electrodes 16, 17 and a plurality of drive electrodes 18, 19, each associated with a column of emitters 21A, 21B. It comprises a plurality of addressing drive units 20A, 20B each able to address and to power the addressing circuits 3, 4, 5, 6 of a column 21A, 21B by way of a column electrode 16, 17 and a drive electrode 18, 19.

The row electrodes 14, 15, column electrodes 16, 17 and drive electrodes 18, 19 make it possible respectively to select, to address and to power a specific addressing circuit out of the set of circuits 3, 4, 5, 6 of the display device.

Thus, by selecting only the row electrode 14 of the display device and by activating the drive unit 20A able to transmit a control voltage V_{c} to the electrode 16 and a drive current I to the electrode 18 of the column 21A, the circuit 3 at the crossover of the electrode of this row 14 and of the electrodes 16 and 18 of this column of emitters 21A is activated, whereas none of the other circuits 4, . . . , 5 of this same column is activated.

FIG. 2 represents light emitters 22, 23, 24 each associated with an addressing circuit 3, 4, 5 for a set of pixels of a column of emitters 21A as well as the addressing drive unit 20A for this column of emitters 21A and the selection control circuits 8 for the addressing circuits 3, 4, 5, 6.

The emitters 22, 23, 24 of the display device are organic light-emitting diodes. They comprise an anode and a cathode. The structure of these diodes is “conventional”, that is to say the anodes are a lower layer, on the substrate side, and the cathodes an upper layer.

These emitters emit a luminous intensity directly proportional to the current which passes through them. Each emitter constitutes an elementary pixel. These elementary pixels are of the same nature (identical colour emission) in the case of a monochrome screen or are structured in the form of red, green and blue trios in the case of a colour screen.

Within the framework of the invention, the set of emitters 22, 23, 24 of a column is associated with subpixels of the same colour. The emitters of three adjacent columns are associated in succession with the colours red, green and blue. The bias voltages necessary in order for the emitters 22, 23, 24 to be traversed by a current of the same value vary as a function of the current-voltage characteristics of these emitters, and in particular as a function of the colour of the subpixels associated with the emitters 22, 23, 24 of each column.

As the addressing circuits 3, 4, 5 of the active matrix 1 are identical, only the circuit 3 will be described in detail.

This circuit 3 comprises a current modulator 26, a switch 28 formed of a transistor, a storage capacitor 29 and a power electrode 30.

The current modulator 26 and switch 28 are thin film transistors, based on a technology using polycrystalline silicon (Poly-Si), amorphous silicon (a-Si) or mono-crystalline silicon (μc-Si) deposited in thin film layers on a glass substrate. Such components comprise three electrodes: a drain electrode and a source electrode between which flows a modulated current called the drain current, and a gate electrode to which the control voltage V_{c} is applied.

The source of the modulator 26 is connected to the anode of the emitter 22, in such a way as to link the modulator 26 and the emitter 22 in series. One 31 of the ends of this series, namely here the drain of the modulator 26, is linked to the drive electrode 18. the gate of the modulator 26 is linked on the one hand, to a first terminal of the capacitor 29 and on the other hand, to a current passage electrode (drain or source) of the switch 28, via an electrical line 33. The other current passage electrode (drain or source) of the switch 28 is linked to the column electrode 16. The gate of the switch 28 is linked to the row electrode 14. The second terminal of each capacitor 29 of the set of circuits 3, 4, 5 of column 21A is connected to the power electrode 30. Finally, the other end 32 of each modulator-emitter series, namely here the cathode of the emitter 22 is linked to a power electrode 34. The two power electrodes 30 and 34 may be connected together to the same potential by a conductor (not represented).

The modulator 26, represented in FIG. 2, is of type n, so that, when operating, its drain current flows between its drain and its source. It will be noted that such a device can also be used to drive TFTs of type p, still with diodes of conventional structure, as illustrated in FIG. 10.

The capacitor 29, disposed between the gate and the source of the modulator 26, is adapted to sustain substantially a constant control voltage at the gate of the modulator 26 for a time interval corresponding to the duration of an image T1, T2 so as to sustain the brightness of the emitter for this duration.

The power electrode 30 is able to provide the voltage necessary to bias to the desired potential one of the terminals of the capacitor 29, as is known in the state of the art.

The drive unit 20A is adapted so as to compensate, with the feedback loop described herein below, the trip threshold voltage Vₜₕ of each modulator 26 of the set of addressing circuits 3, 4, 5 of the column 21A and to power the emitters 22, 23, 24 of the column of emitters 21A.

For this purpose, it comprises an operational amplifier 35 having an inverting input −, a non-inverting input + and an output. The output of this amplifier 35 is connected to the column electrode 16 and its non-inverting input + is linked to the drive electrode 18 ensuring the powering of the emitters of the column via their associated modulator. Thus, this non-inverting input + is connected simultaneously to the anode of each emitter 22, 23, 24 of the column 21A via the modulator 26 which is associated with it.

Consequently, a loop for feedback of the amplifier 35 is formed by the drive electrode 18, the end 31 of the modulator-emitter series, the modulator 26, the line 33 and the column electrode 16 each time a switch 28 of an addressing circuit 3, 4, 5 of the column of emitters 21A is closed. It should be noted that the end 31 of the modulator-emitter series which forms part of the feedback loop corresponds, in the embodiments presented in FIGS. 2 and 10, to one out of the drain or the source of the modulator of this series.

The amplifier 35 is able to operate in feedback and to thus compensate for the trip threshold voltage Vₜₕ of each modulator 26 of the addressing circuits 3, 4, 5 of the column of emitters 21A, as will be explained subsequently in the description.

Moreover, the drive unit 20A is able to address and to power the emitters 22, 23, 24 of the column 21A by the drive current I. This current I depends on the sum of the values of the display voltages V_{data 22}, V_{data 23}, V_{data 24} addressed to the emitters 22, 23, 24 of this column 21A.

For this purpose, it comprises a drive current generator 36 and a reference voltage generator 38, which are linked respectively to the non-inverting input + and to the inverting input − of the amplifier 35.

The current generator 36 is formed by a variable voltage generator 39 linked in series to a resistor 40. The drive electrode 18 is linked to the output of the resistor 40, to the node 42, which therefore forms one of the outputs of the current generator 36.

The generator 39 is a variable voltage generator whose voltage varies as a function of the values of the display signal V_{data 22}, V_{data 23} which are intended to be addressed to the emitters 22, 23 as will be explained subsequently in the description.

The generator 38 is a generator adapted for delivering a reference voltage which is fixed during settings of the display device and which is specific to each column. As a variant, it is also possible to use a variable voltage generator; the variation of the reference voltage is a function of the column of emitters 21A which is addressed will be made explicit subsequently in the description.

The output of the generator 38 is connected to the inverting input − of the amplifier 35, via, optionally, a resistor 44. This resistor 44 is not absolutely necessary for the operation of the drive unit 20A. It merely has advantageous function of balancing between the two inputs of the operational amplifier 35.

Likewise optionally, a capacitor 46 is linked between the inverting input − of the amplifier 35 in the output of this amplifier. The resistor 44 and the capacitor 46 constitute a compensation array which makes it possible to advantageously increase the accuracy and the stability of the circuit.

The drive unit 20A also comprises data storage means 48 and a module for control 50 of the generators 38 and 39.

The storage means 48 comprise a database 52 adapted for storing on one hand the value of the display signal V_{data 22}, V_{data 23} which is addressed to each emitter 22, 23 of the column 21A in the course of the previous image duration T1 and, on the other hand a datum for identifying or locating the emitter 22, 23 to which this value has been addressed.

These storage means 48 also comprise a directory 54 adapted for storing a reference voltage value to be associated with the set of emitters of the column 21A. This value is dependent on the colour red, green or blue associated with the emitters 22, 23 of the column 21A.

The emitters associated with different colours exhibit different current-voltage characteristics, as may be seen in FIG. 12. Consequently, it is necessary to apply different voltages to the terminals of a red emitter and to the terminals of a blue emitter to obtain the same luminance and the same value of the current passing through these emitters.

The reference voltage values of the directories 54 of each column are fixed here as a function of the colour of the emitters of a column 21A. This operation is carried out in the factory, during settings of the display device which are performed before it is brought into service. These reference values are established so as to compensate for the variations between the current-voltage electrical characteristics and/or luminous characteristics of the various emitters of the device, as will be described later.

Generally, as these characteristics depend mainly on the colour of emission of the emitters, there will be three different values of reference voltage, a first value V_{ref.R} common to the set of red emitters of a first column, a second value V_{ref.G} common to the set of green emitters with a second column and a third value V_{ref.B} common to the set of blue emitters of a third column. According to a more complex variant, these values of reference voltage are specific to each column of emitters, so as to compensate for the variations of the current-voltage electrical characteristics and/or luminous characteristics between the emitters of various columns, even when they have the same emission colour.

A current can flow through an emitter only if the display signal V_{data} which is addressed to it is greater than the reference voltage V_{ref} which is associated with it. To avoid having to use display signals of overly high values, the lowest possible values of reference voltage will preferably be established, during settings of the display device, while still obtaining the desired compensations.

The control module 50 is linked to the storage means 48 for searching for and recording information in said means.

Moreover, the module 50 is able to receive the display signal transmitted by the system 7 and to control the generators 38 and 39 as a function of this signal and information stored in the storage means 48.

When operating, the circuits 8 and 10 are able to address, to power and to select in succession the set of emitters 22, 23, 24 of the matrix 1.

Upon switch-on, at the start of a first image frame T1, in the course of a step 60, represented in FIG. 3, the drive unit 20A and the circuit 8 control the lighting of the first emitter 22 of the column 21A. This step 60 comprises steps 62 to 69.

In the course of step 62, the circuit 8 generates a selection pulse V_{select 22} at the row electrode 14. This pulse, represented in FIG. 4, is able to close the switch 28.

In parallel, in the course of a step 64, the module 50 interrogates the directory 54 to ascertain the reference voltage associated with the column of the emitter 22. This reference voltage is in particular dependent on the colour of the subpixels associated with the emitters 22, 23, 24 of this column.

During a step 66, the module 50 controls the generator 38 so that the latter delivers the reference voltage V_{ref 21A} intended for the emitters of the column 21A whose value is constant and equal to V_{ref a}.

In parallel, in the course of step 68, the module 50 receives from the control system 7 the value Vₐ of the display voltage V_{data 22} to be addressed to the emitter 22 and the identification or the position of the addressed emitter 22 associated with this value. Then, the module 50 records in the database 52 this value Vₐ and the identification of the emitter to which this value is addressed.

At the same time, in the course of step 69, the module 50 controls the generator 39 so that the latter generates the value Vₐ of the display voltage V_{data 22} to be addressed to the emitter 22, as represented in FIG. 6.

Consequently, the generator 38 provides a reference voltage V_{ref 21A} equal to the V_{ref a}, to the inverting input − of the amplifier 35. At the same time, the generator 39 applies to the resistor 40, a voltage V_{data 22} equal to Vₐ, represented in FIG. 6. This voltage Vₐ, generates a drive current I=I₂₂, which is introduced into the drain of the modulator 26, by way of the drive electrode 18. This drive current I=I₂₂, represented in FIG. 7, is defined by the following relation:

$${I}_{22} = \frac{{V}_{a} - {V}_{ref a}}{R}$$

in which Vₐ is the value of the display voltage V_{data 22} generated by the generator 39, V_{ref a} is the value of the reference voltage generated by the generator 38, and R is the value of the resistor 40. It should be noted that the optional resistor 44 does not come into the calculation of the current, since no significant current, at least as regards the value of the drive current of I₂₂, flows through this resistor.

By considering that the modulator 26 of the circuit 3 linked in series to the first emitter 22 operates in its saturation mode (V_{gs}−Vₜₕ<V_{ds}), the drain current passing through it is equal to the drive current I and the following relation holds:

$$I = {I}_{22} = {k ( {V}_{gs} - {V}_{th} )}^{2} \\ = \frac{{V}_{a} - {V}_{ref a}}{R}$$

in which I₂₂ is the drain current passing through the modulator 26, V_{gs} is the voltage between the gate and the source of the modulator 26, k is a constant which depends on the intrinsic characteristics of the modulator 26, Vₜₕ is the trip threshold voltage of the modulator 26 and V_{ds} is the voltage between the drain and the source of the modulator 26.

By virtue of the feedback loop according to the invention, the potential difference between the inverting input − and the noninverting input + at the amplifier 35 vanishes. The voltage at the node 42 is then equal to V_{ref a}. The amplifier 35 therefore delivers to the gate of the modulator 26 a control voltage V_{c} which adjusts automatically to a value such that the modulator 26 and the emitter 22 in series are traversed by a current I=(Vₐ−V_{ref a})/R which is therefore independent of the trip threshold voltage Vₜₕ of the modulator 26. Compensation for the trip threshold voltage of the emitter 22 of the device is thus obtained directly without involving a measurement of the current passing through this emitter.

A value V_{gs} is deduced automatically from the value of the control voltage V_{c}.

The value of the control voltage V_{c} is dependent, not only on the display signal of the emitter V_{data 22} and the reference voltage V_{ref a} associated with this emitter, but also the trip threshold voltage Vₜₕ of the modulator 26.

As the value Vₐ of the display voltage V_{data 22} is imposed by the generator 39, since the voltage V_{ref a} is imposed by the generator 38, since the trip threshold voltage Vₜₕ is intrinsic to the characteristics of construction of the modulator 26, the control voltage V_{c} applied to the gate of the modulator 26 is adapted and modulated by the amplifier 35 so as to compensate for the trip threshold voltage Vₜₕ of this modulator.

Consequently, the control voltage V_{c} at the output of the amplifier 35 adjusts exactly to the voltage necessary to address the emitter 22 with the value Vₐ of the display voltage V_{data 22} and does so regardless of the value of the trip threshold voltage Vₜₕ of the modulator 26 and does so even if said voltage varies over time.

This control voltage V_{c} is then sustained at the gate of the modulator 26 by the capacitor 29 throughout the remainder of the image duration, while the switch 28 of the circuit 3 is reopened, as is known in the prior art.

In the course of a step 70, the second emitter 23 of the column 21A is lit. Step 70 comprises steps 72 to 79.

In the course of step 72, the circuit 8 delivers a selection pulse V_{select 23}, such as represented in FIG. 5, to the row electrode 15.

In the course of a step 74, the module 50 determines the reference voltage V_{ref 21A} associated with the column of the emitter 23, by interrogation of the, storage means 48. As the emitter 23 is in the same column as the emitter 22 and since consequently these emitters are associated with the same colour, the value V_{ref a} of this reference voltage V_{ref 21A} is identical to the value V_{ref a} of the reference voltage V_{ref 22} generated during the addressing of the first emitter 22.

In the course of a step 76, the module 50 controls the reference generator 38, so that the latter generates the voltage V_{ref a}, determined during step 74.

In parallel, in the course of a step 77, the module 50 receives from the system 7 and records in the database 52, the value V_{b} of the display voltage V_{data 23} to be addressed to the emitter 23 and represented in FIG. 6, and the identification or the position of the addressed emitter 23 associated with this value.

In the course of a step 78, the module 50 adds up a value Vₐ of the display voltage V_{data 22} previously addressed to the emitter 22 of the same column and the value V_{b} of the display voltage V_{data 23} intended to be addressed to the next emitter 23.

Then, in the course of a step 79, the module 50 controls the generator 39 so that the latter delivers a display voltage equal to the voltage value calculated during step 78, namely Vₐ+V_{b}.

Consequently, the new drive current becomes I=I₂₃+I₂₂, represented in FIG. 9, flowing through the resistor R and the drive electrode 18 whose common point is connected to the noninverting input + of the amplifier 35, is defined by the following relation:

$$I = {I}_{22} + {I}_{23} = \frac{{V}_{data 22} + {V}_{data 23} - {V}_{ref a}}{R}$$

The current I₂₂ =(V_{data 22}−V_{ref a})/R necessary for the illumination of the emitter 22, continues to power the modulator 26. Specifically, the same control voltage V_{c} is sustained at the gate of the modulator 26 of the first circuit 3, by the capacitor 29, and not by the amplifier 35 since the switch 28 of the circuit 3 is now open. This voltage V_{c} commands the intensity of the current powering the emitter 22 so that this intensity is equal to the intensity programmed in the course of step 60.

The remaining current I₂₃=I−I₂₂=V_{data 23/}R on the drive electrode 18 powers the modulator 26 of the second circuit 4. As the switch 28 of the circuit 4 has been closed in the course of step 72, the column electrode 16, the amplifier 35, the drive electrode 18, the end 31 of modulator-emitter series, the modulator 26 of the second circuit 4 and the line 33 of the second circuit 4 form a new feedback loop for the amplifier 35. Consequently, the control voltage V_{c} exiting the amplifier 35 compensates as previously for the trip threshold voltage Vₜₕ of the modulator 26 of the second circuit 4.

The method of addressing of the display device according to the invention is continued by the addressing of the whole set of emitters 22, 23, 24 of the column 21A in the course of the same first image frame of duration T1, by implementation of steps similar to steps 72 to 79, for each addressing circuit 3, 4, 5 of the column 21A. In particular, the database 52 then contains the p values V_{data.n} of display voltage addressed to each emitter of the column 21A in the course of this first image frame and the module 50 controls the generator 39 so that the latter delivers a display voltage

$$V = {\sum }_{n}^{ } {V}_{data . n} .$$

The drive current I passing through the drive electrode 18 is then defined by the following general relation:

$$I = {\sum }_{n}^{ } {I}_{n} = \frac{( {\sum }_{n = 1}^{p} {V}_{data . n} ) - {V}_{ref 21 A}}{R}$$

in which:

I is the drive current generated by the drive unit 20A and flowing through the drive electrode 18;

Iₙ is the current flowing through the emitter n;

V_{data n} is the value of the image display voltage addressed to emitter n;

V_{ref 21A} is the value of the reference voltage associated with the emitters of column 21A; and

p is the number of emitters in the column 21A.

After an image duration T1, the whole set of emitters 22, 23, 24 of the column 21A is illuminated as a function of the display voltages representative of the image data to be displayed by these emitters, and the circuit 3 is addressed for the second time in the course of a step 80. This step 80 comprises steps 82 to 89.

Steps 82, 84, 86, 87, 88 and 89 are respectively identical to steps 62, 64, 66, 68 and 69 and will not be described again. For this second addressing of the circuit 3, these steps are adapted so that the module 50:
receives from the database 52 the value Vₐ of the display voltage V_{data 22} previously addressed to the emitter 22 in the course of the previous image frame and receives from the system 7 and records in the database 52 the new value V′ₐ of the display voltage V′_{data 22} to be addressed to the emitter 22, in place of the old value Vₐ.
subtracts the old value Vₐ from the sum

$${\sum }_{n}^{ } {V}_{data . n}$$

and adds the new value V′ₐ to it.

The module 50 then controls the generator 39 so that the latter delivers a display voltage equal to the new value calculated of the sum

$${\sum }_{n}^{ } {V}_{data . n} .$$

A second addressing of the circuit 4 is performed in the same manner. After an image duration T2, the whole set of emitters 22, 23, 24 of the column 21A is illuminated as a function of display voltages representative of the new image data to be displayed by these emitters.

The other image frames then follow the previous ones like the image frame T2 followed the image frame T1.

In the exemplary embodiment of the invention, as illustrated in FIG. 6, a value of the reference voltage V_{ref 22} equal to V_{ref a} has been applied to the inverting input − of the amplifier 35 and a value of the display voltage V_{data 22} equal to Vₐ has been addressed to the emitter 22 in the course of image duration T1. This value of the voltage Vₐ continues to be addressed in the course of the new image duration T2.

Consequently, the sum

$${\sum }_{n = 1}^{p } {V}_{data . n}$$

is not modified in the course of the second image duration T2 and the charges stored by the capacitor 29 of the circuit 3 in the course of the previous image duration T1 is not modified.

Likewise, during the step (not represented in FIG. 3) of lighting of the second emitter 23, the value of the display voltage addressed to the emitter 23 is equal to V_{b} in the course of the first and previous image duration T3 (FIG. 6), then is zero in the course of the next image duration T4.

Consequently, the sum

$${\sum }_{n = l}^{p } {V}_{data - n}$$

is simply decreased by the value V_{data} so that the whole of the charge accumulated on the capacitor 29 of the circuit 4 is eliminated and so that the latter exhibits a zero potential, characteristic of an unlit diode.

Advantageously, it may be seen that this device and this method of display make it possible to avoid an initialization phase prior to the programming of the addressing circuits 3, 4, 5.

Advantageously, the use of a reference voltage applied to one of the inputs of the amplifier 35 and specific to each column of emitters, or to groups of columns as here groups of different colours, advantageously makes it possible to reduce the consumption of the display device. Specifically, if the values of the reference voltages are chosen not only in such a way as to compensate for the variations of the electrical and/or luminous characteristics of the emitters of various columns but also in such a way as to obtain the lowest possible mean value of reference voltage of each column, then the values V_{data} of the display signals can be shifted correspondingly and decreased, thereby decreasing the electrical power to be generated by the power generator 39.

In the case of FIG. 2 of OLED display device with conventional structure, it is the anode of the emitters 22, 23 which forms the interface for the active matrix 1 (diodes with “conventional” structure): the drain (type n case) or the source (type p case) of the modulators 26, is then connected to the drive electrode 18, and the cathode of the emitters 22, 23 is connected to the electrode 34. The drive electrode 18 is then connected to the node 42 where one of the outputs of the powering means 36 and the non-inverting input + of the amplifier 35 come together.

However, as illustrated in FIG. 11, the present invention applies also to display devices with so-called inverted structure, in which the cathode of the emitters forms the interface for the active matrix: the drain (type p case) or the source (type n case) of the modulators 26 is then connected to the drive electrode 18, and the anode of the emitters 22, 23 is connected to the electrode 34. The drive electrode 18 is connected to the node 42 where one of the outputs of the power means 36 and, this time, the inverting input − of the amplifier 35 come together. This circuit being much more stable than the one described in respect of diodes with conventional structure, advantageously, no resistor 44 or any balancing and/or compensating capacitor 46 is now necessary. The display signals then correspond to negative voltages and the currents of the diodes are “pulled” from the power electrodes 34.

As a variant, the generator 38 is able to modify the reference voltage as a function of the ageing of the emitters or to lower it in a low consumption mode.

As a variant, a reference voltage is associated with each column of emitters. In this case, the storage means 48 comprise a database able to store the values of the reference voltages to be applied to each column of emitters. The drive unit 50 is suitable for searching through this database for the value of the reference voltage to be applied to the inverting input − of the amplifier 35 as a function of the identification or position of the column of this emitter.

According to the invention, during settings before bringing the device into service, the difference (V_{ref x}−V_{ref y}) is preferably established in such a way as to compensate for the differences in electrical and/or luminous characteristics of the various columns of emitters.

1. Active-matrix image display device, comprising:
several light emitters forming an array of emitters distributed in rows and columns, each emitter being able to be addressed periodically by a value of a display signal, which value is representative of a datum of display of an image duration; and
a current modulator linked in series to each light emitter of the array so as to form emitter-modulator series, the said modulator comprising a source, a drain, a gate, the said modulator being able to be traversed by a drain current so as to power the said emitter, for a voltage between one out of the drain and source, and the gate greater than or equal to a trip threshold voltage of this modulator; and
a storage capacitor for electric charge, able to maintain a control voltage at the gate of each modulator for the said image duration; and
selection means able to select the emitters of one and the same row; and
means of driving the illumination of the emitters comprising, for each column, means for powering these emitters comprising an output connected to one of the ends of each emitter-modulator series of the said column and at least one operational amplifier for controlling the corresponding modulators having an inverting input, a non-inverting, and an output, the said output of the amplifier being able to be connected to the gate of each modulator of this column when an emitter linked to this modulator is selected, so as to apply to the said gate, the said control voltage;
wherein one out of the non-inverting input and the inverting input of the operational amplifier is connected to the said output of the powering means so as to form, with the gate of the modulator, linked to the output of the operational amplifier, a loop for feedback of the operational amplifier, when one of the said emitters is selected.

2. Device according to claim 1, wherein one of the said ends of each emitter-modulator series of the said column, which is connected to the output of the said powering means, corresponds to the drain or to the source of the said modulators.

3. Device according to claim 1, wherein one out of the non-inverting input and the inverting input of the operational amplifier, connected to the output is able to receive a signal dependent on the value of the from the said column.

4. Device according to claim 1, wherein the said powering means furthermore comprise a drive generator which is suitable for feeding power discontinuously in succession to each of the emitters of a column by provision of a drive signal to one of the said ends of the emitter-modulator series corresponding to the said emitter, the said drive signal depending on the value of the display signal, which value is intended to be addressed to a selected emitter from the said column.

5. Device according to claim 4, wherein the said drive generator comprises a display voltage generator and a resistive element linked in series, and in that the voltage generator is suitable for generating a voltage dependent on the value of the display signal, which value is intended to be addressed to a selected emitter from the said column.

6. Device according to claim 1, wherein said powering means furthermore comprise a drive generator able to supply power continuously to the whole set of emitters of a column by providing one and the same drive signal to one of the said ends of each emitter-modulator series of a column, the said drive signal being dependent on the sum of the values of the display signal that were previously addressed and are currently being addressed to the whole set of emitters of the column for an image duration.

7. Device according to claim 6, wherein the said drive generator comprises a display voltage generator and a resistive element linked in series, and in that the voltage generator is suitable for generating a voltage dependent on the sum of the values of the display signal that were previously addressed and are currently being addressed to the whole set of emitters of the column for an image duration.

8. Device according to claim 7, wherein it comprises no means of switching between the said output of the powering means and each of the ends of the emitter-modulator series of the column.

9. Device according to claim 7, wherein the voltage generator is linked to the resistive element so as to deliver a drive current obtained on the basis of the following relation:
$$I = \frac{( {\sum }_{n = l}^{p} {V}_{data n} ) - {V}_{ref n}}{R}$$
in which R is the resistive element,
V_{ref n} is a reference voltage associated with emitter n, and
V_{data n} is the value of the display voltage addressed to emitter n, and
P is the total number of emitters in a column.

10. Device according to claim 1, wherein said drive means furthermore comprise a reference generator able to deliver a reference signal to the other out of the inverting input and the non-inverting input of the operational amplifier.

11. Device according to claim 10, wherein each emitter exhibits particular electrical and/or optical properties and in that the value of each reference signal is dependent on the said electrical and/or optical properties.

12. Device according to claim 10, wherein each emitter is associated with the illumination of a colour, and in that the reference signal is able to be modulated as a function of the colour assigned to the said selected emitter.

13. Device according to claim 10, wherein the emitters are grouped into pluralities of adjacent emitters suitable for each emitting a different colour, and in that, for each plurality, the said reference signals are allocated to the various emitters of this plurality in such a way that the addressing of these emitters by one and the same display signal value brings about the emission of a white hue by this plurality.

14. Device according to claim 1, wherein the said drive means furthermore comprise data storage means able to store the value of the display signal which is addressed to each emitter for an image duration.

15. Method of control for active-matrix image display device comprising several light emitters forming an array of emitters distributed in rows and columns, each emitter being able to be addressed periodically by a value of a display signal, which value is representative of a datum of display for an image duration; a current modulator comprising a source, a drain, a gate, one out of the drain or the source of each modulator being linked in series to an emitter of the array so as to form an emitter-modulator comprising two ends; selection means able to select the emitters of a row; a storage capacitor for electric charge, able to maintain a control voltage at the gate of the or each modulator for the said image duration; means of driving the illumination of the emitters of a column comprising at least one operational amplifier having an inverting input, a non-inverting input and an output, the method comprising the following steps
transmission by the means of selection, of a selection signal to a row of emitters; and
application by the drive means of a drive signal to one of the ends of each emitter-modulator series of a column;
application by the drive means of a control signal to the gate of each modulator, linked to the selected emitter,
wherein it furthermore comprises the following step:
selection of a row of emitters so as to form a loop for feedback of the operational amplifier with the gate of the modulator, linked to the output of the operational amplifier, and with one out of the non-inverting input and the inverting input of the operational amplifier, linked to the said output of the means of powering of these emitters.

16. Method according to claim 15, wherein the drive signal is dependent on the sum of the values of the display signals addressed to the whole set of emitters of the column for an image duration.
